(19) United States
(12) Patent Application Publication
(10) Pub. No.: US 2006/0092869 A1
(43) Pub. Date: May 4, 2006

(54) Data transmission method and system for multiple harq processes

(75) Inventor: Christoph Herrmann, Aachen (DE)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics, N.V., Eindhoven (NL)

(21) Appl. No.: 10/528,680

(22) PCT Filed: Sep. 22, 2003
(86) PCT No.: PCT/IB03/04086

§ 371 Date: Mar. 21, 2005

(30) Foreign Application Priority Data
Sep. 24, 2002 (DE) 102 44 696.2

(51) Int. Cl. H04Q 7/00

(52) U.S. Cl. 370/314

(57) ABSTRACT

The invention relates to a method of transmitting data packets between a transmitter and a receiver in predefined numbered slots, wherein the transmitter is provided for sending in one slot data of different streams multiplexed in a data packet to the receiver, wherein a STOP command is provided for at least one numbered slot, wherein the receiver is provided for sending the STOP command to the transmitter, wherein a mapping table is provided which maps each stop command of the numbered slots to a set of streams of the respective slot, wherein the stop command is provided for blocking a set of the streams of the respective slot according to the mapping table.

The invention relates to a method of transmitting data packets between a transmitter and a receiver as well as a respective data transmission system.

Such a method is known, for example, from document 3GPP TS 25.308 V5.2.0 (2002-2003), Technical Specification, 3^{rd} Generation Partnership Project; Technical Specification Group Radio Access Network; High Speed Downlink Packet Access (HSDPA); Overall Description; Stage 2 (Release 5), in which data are transmitted at high speed in the downlink over the High Speed Downlink Shared Channel (HS-DSCH).

This known transmission method on the HS-DSCH (High Speed Downlink Shared Channel) provides that over up to N=8 different time channels data are transmitted according to the Stop&Wait protocol: data packets are acknowledged on the time channel after each transmission i.e. if the decoding was possible without any errors, an ACK positive ACKnowledgement) is sent back by the mobile station, if it contained errors, the mobile station sends a NACK (Negative ACKnowledgement) back. A NACK then implies the request for additional redundancy to finally be able to transmit the packet free of errors.

Each of these up to 8 time channels is also referred to as the HARQ process (Hybrid Automatic Repeat Request). Since a Stop&Wait protocol is used in each HARQ process, which protocol blocks the transmission until an acknowledgement is obtained, for a maximization of the throughput data packets are transmitted after one another according to various HARQ processes. Moreover, on an additional separate HS-SCCH (High Speed Shared Channel Control Channel), for example the number or identity of the respective HARQ process is announced to the receiving mobile station, for which process a transmission takes place so that it can be unambiguously determined in case of transmission repetitions which initial transmission the repeated data relate to.

Acknowledgements (ACK, NACK) are sent in the up-link (UL) so that it is clearly obvious from their time slot, which HARQ process in the downlink (DL) the acknowledgement refers to. For this purpose a similar slot structure to the one in DL is defined in the UL, whereas the slot structure in the UL compared to that in the DL is shifted in time by a fixed predefined value. In the downlink three successive slots form a so-called transmission time interval (TTI) in which exactly one packet can be transmitted. In the UL three slots are assigned to each TTI. In the first slot of each TTI, ACK or NACK is transmitted, whereas in the next two slots an estimate for the channel quality (CQI) (Channel Quality Indication) can be sent, if this is configured. The mobile station shows to the base station by means of these CQI bits how good the channel quality has been in the previous TTIs. In this way the base station receives additional criteria for selecting a possibly better suitable modulation or coding scheme for the next packet transmissions.

In the HARQ processes packet data are transmitted of different connections, some of which ending directly in a mobile station whereas other connections are led via interfaces to external components or devices. When these external interfaces are also operated in wireless fashion, for example by radio, as is the case with Bluetooth or infrared connections, the available data rate can vary in dependence on time via this interface, for example by shadowing. If the data rate over this interface diminishes during operation of a connection, it may happen that the data sent in the downlink (via the HS-DSCH) can no longer be conveyed over the external radio interface. They will dwell so long in the buffer memory of the mobile station until it is full and are then erased.

It is an object of the invention to provide an improved method of controlling the data streams. Another object of the invention is to provide a relating system and a relating terminal.

This object is achieved according to the invention by a method having the characteristic features of claim 1, a terminal having the characteristic features of claim 4 and a system having the characteristic features of claim 5.

Advantageously by means of the method according to the invention the receiver is enabled to slow down the transmission rate until a bottleneck on an external interface of the receiver is remedied, so that the undesired data packets as a result of the bottleneck can be retained in the transmitter from the start. This avoids that packets are unnecessarily transmitted from the transmitter to the receiver although they are to be rejected by the receiver, e.g. as a result of the bottleneck on the external interface.

By means of the mapping table it is possible to give the STOP command of each numbered slot an individual meaning. The mapping table indicates which set of streams of the respective slot should be blocked when a STOP command is sent by the receiver to the transmitter.

This allows to only block the data which are e.g. adressed to a external interface of the receiver, while all further data, e.g. control data for controlling the behavior of the receiver are not affected by the STOP command.

The data packets between the transmitter and the receiver are advantageously transmitted according to a Stop & Wait protocol. By means of the Stop &Wait protocol data packets are acknowledged on the time channel after each transmission i.e. if the decoding was possible without any errors, an ACK-message (positive ACKnowledgement) is sent back by the receiver. If the transmission contained errors, the receiver sends a NACK (Negative ACKnowledgement) back. A NACK then implies the request for additional redundancy to finally be able to transmit the packet free of errors.

According to a preferred embodiment of the invention as claimed in claim 2 the transmitter and the receiver are provided with the mapping table by means of a configuration message.

This configuration message may e.g. be sent when the transmission link between the transmitter and the receiver is established. In addition the mapping table may be changed during an established transmission link, e.g. when the streams are reconfigured.

According to a preferred embodiment of the invention as claimed in claim 3 the receiver, once it has sent a STOP command to block a set of streams, starts a timer assigned to this set and, once the timer has stopped running, sends a further STOP command in so far as the set of streams to be blocked are still to be blocked.

Once the timer has stopped running, the receiver checks whether the bottleneck to the external interface link still exists. If this is the case, it again sends a STOP command.

By means of this it is not necessary to provide for an extra command to remove the blocking of a set of streams.

Not all the CQI bit combinations are nowadays provided for the channel quality indication. One of the unused bit combinations can be advantageously used for having a STOP command available.

The transmitter of the system according to the invention may be e.g. a base station of a mobile telecommunication system and the receiver a mobile station of such a system. The terminal according to the invention may be e.g. the mobile station of such a system.

Such mobile stations may comprise a external interface, e.g. a Bluetooth-interface or a infra-red interface. If the data transmission between the mobile station and the external interface is disturbed or interrupted due to deteriorated channel conditions, the mobile station would send the STOP comand to the base station.

These and other aspects of the present invention will become apparent from and elucidated with reference to the embodiments described hereinafter.

Exemplary embodiments of the present invention will be described in the following, with reference to the following drawings:

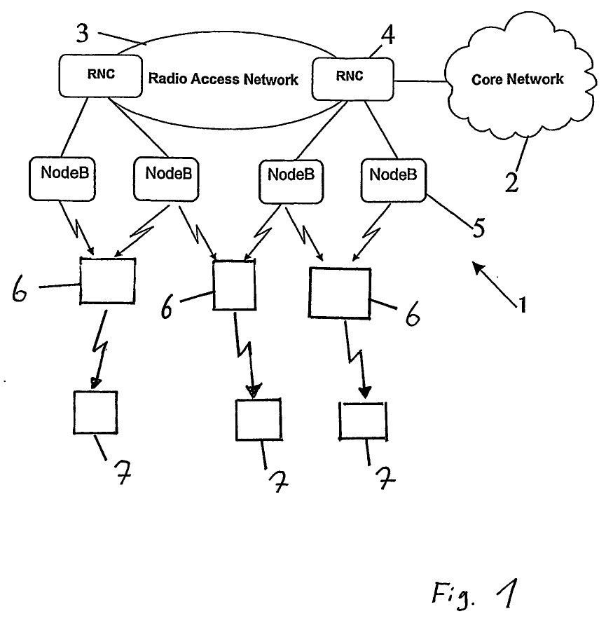

FIG. 1 shows a simplified architecture of a UMTS-mobile telecommunications network,

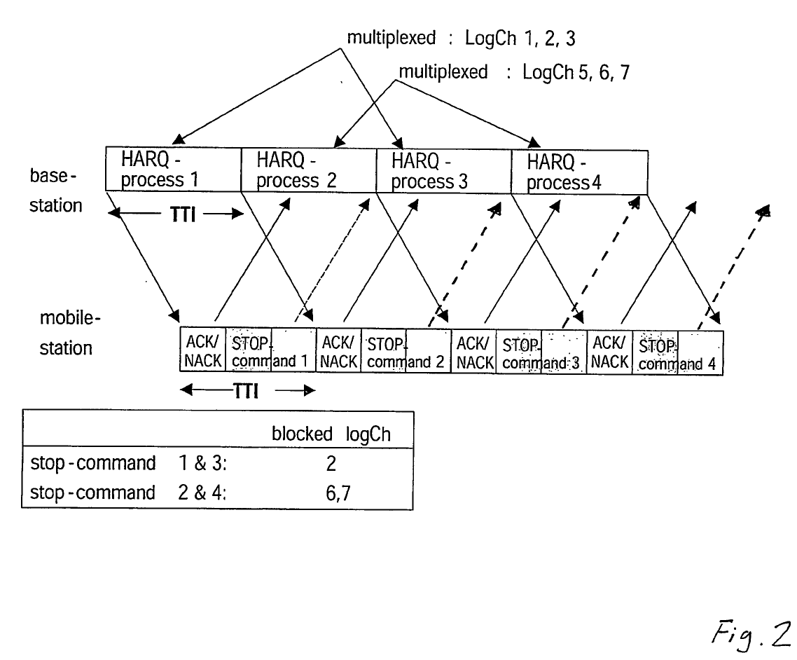

FIG. 2 shows a exemplary embodiment of a data transmission scheme for operating the data transmission between a base station and mobile station of the UMTS-mobile telecommunications-network depicted in FIG. 1.

FIG. 1 shows schematically a UMTS network 1 which comprises a core network 2 and a UMTS Terrestrial Radio Acess Network (UTRAN) 3. The UTRAN 3 comprises a number of Radio Network Controllers (RNCs) 4, each of which is coupled to a set of neighbouring Bases Stations (BSs) 5. BSs are often refered to as NodeBs. Each BS 5 is responsible for communicating with mobile stations (or User Equipment (UE) 6 within a given cell via a air interface. The RNC 4 is responsible for routing user and signalling data between a BS 5 and the core network 2. The mobile stations 6 comprise a external air interface, e.g. a bluetooth interface or a infrared interface. Via this external interface the mobile terminals 6 are connectable with electronic devices 7. The electronic devices 7 can be e.g. personal computers.

FIG. 2 illustrates a data transmission scheme for transmitting data between BSs and UEs of a UMTS network in which data are transmitted at high speed in the downlink over the High Speed Downlink Shared Channel (HS-DSCH). The exemplary embodiment provides that over N=4 different time channels data are transmitted according to a Stop &Wait protocol. By means of the Stop &Wait protocol data packets are acknowledged on the time channel after each transmission i.e. if the decoding of a packet was possible without any errors, an ACK-message (positive ACKnowledgement) is sent back by the mobile station, if the decoding of a packet indicates errors, the mobile station sends a NACK (Negative ACKnowledgement) back. A NACK then implies the request for additional redundancy to finally be able to decode the packet free of errors.

Each of these 4 time channels is also referred to as the HARQ process (Hybrid Automatic Repeat Request). Since a Stop&Wait protocol is used in each HARQ process, which protocol blocks the transmission until an acknowledgement is obtained, for a maximization of the throughput data packets are transmitted after one another according to various HARQ processes. Moreover, on an additional separate HS-SCCH (High Speed Shared Channel Control Channel), for example the identity or number of the respective HARQ process is announced to the receiving mobile station, for which process a transmission takes place so that it can be unambiguously determined in case of transmission repetitions which initial transmission the repeated data relate to.

Acknowledgements (ACK, NACK) are sent in the up-link (UL) from the mobile station to the base station so that it is clearly obvious from their time slot, which HARQ process in the downlink (DL) the acknowledgement refers to. For this purpose a similar slot structure to the one in DL is defined in the UL, whereas the slot structure in the UL compared to that in the DL is shifted in time by a fixed predefined value. In the downlink three successive slots form a so-called transmission time interval (TTI) in which exactly one packet can be transmitted. In the UL also three slots are assigned to each TTI. In the first slot of each uplink TTI, ACK or NACK is transmitted, whereas in the next two slots with associated configuration an estimate for the channel quality (CQI) (Channel Quality Indication) can be sent. The mobile station shows to the base station by means of these CQI bits how good the channel quality has been in the previous TTIs. In this way the base station receives additional criteria for selecting a possibly better suitable modulation or coding scheme for the next packet transmissions.

In the HARQ processes packet data are transmitted of different connections, some of which ending directly in a mobile station whereas other connections are led to interfaces to external components or devices. When these external interfaces are also operated in wireless fashion, for example by radio, as is the case with Bluetooth (or infrared connections), the available data rate can vary in dependence on time via this interface, for example, by shadowing. If the data rate over this interface diminishes during operation of a connection, it may happen that the data sent in the downlink (via the HS-DSCH) can no longer be conveyed over the external radio interface. In order to avoid that the data has to be erased when the buffer memory is full, a STOP command is provided. The STOP command can be sent by the mobile station to the base station. Not all the CQI bit combinations are nowadays provided for the channel quality indication. One of the unused bit combinations can be advantageously used for having this STOP command available.

The STOP command of each numbered slot is assigned to the downlink data which should really no longer be sent temporarily because the external interface via which they are to be transmitted now forms a bottleneck. According to an exemplary embodiment of the invention this is realized by means of a mapping table known to the base station and the mobile station. All further data, more particularly control data for controlling the behavior of the mobile station for example (for Radio Resource Control or Mobility Management), should not be affected by this. Therefore, an assignment of the STOP command to the HARQ processes (and thus indirectly to exactly one priority class since according to 3GPP TS 25.321 V5.1.0 (2002-06) 3rd Generation Partnership Project; Technical Specification Group Radio Access Network; MAC protocol specification (Release 5), which is herewith included for reference, the packet sent by a HARQ process contains data of exactly one priority class) would not be favourable, because the individual HARQ processes transmit in multiplex mode data of different logical channels or different radio bearers, which logical channels and radio bearers are defined in “3GPP TS 25.301 V5.2.0 (2002-09) 3rd Generation Partnership Project; Technical Specification Group Radio Access Network; Radio Interface Protocol Architecture (Release 5)”, which herewith incorporated by reference. In fact it could be achieved by suitable configuration that the data of a Bluetooth link or Inrafred link are assigned to exactly one priority class and that data of links terminating at the mobile station do not use this priority class. However, it would then be impossible for the data transmitted over the Bluetooth link to have different priorities themselves. Also the number of priority classes is relatively small with 8, so that it seems unfavorable to provide one priority class exclusively for data of a Bluetooth link (and possibly another one for data of an IR link).

According to an exemplary embodiment of the invention a modified assignment of the STOP commands to the respective DL streams is provided. Instead of assigning the STOP command to exactly one priority class, the identity or number of the HARQ process, in the assigned uplink transmission time interval (UL TTI) of which the STOP command is transmitted, may be defined as a pointer to

one of the 8 priority classes,

one of the 15 logical channels, or

one of the 32 radio bearers,

which the NodeB should block, when receiving the STOP command.

Thus if a STOP command is sent in the UL TTI of the HARQ process X, the STOP command by means of this mapping table e.g. relates to:

the priority class Y when it is sufficient to block all the links that belong to this priority class,

the logical channel Y if a single logical channel is to be blocked,

the radio bearer Y if a single radio bearer is to be blocked.

The mapping table may also mix the assignment to radio bearers, logical channels and priority classes. If four HARQ processes are executed, this mapping table could then look as follows:

| STOP | | | |
|---|---|---|---|
| command | | | |
| assigned | STOP command | STOP command | STOP command |
| to HARQ | assigned to | assigned to | assigned to |
| process 1 | HARQ process 2 | HARQ process 3 | HARQ process 4 |
| stops radio | stops logical | stops priority | stops priority |
| bearer 5 | channel 4 | class 2 | class 3 |

If a plurality of links are to be blocked, a STOP command in the UL TTI of the HARQ process X may also block, for example

all priority classes up to class Y starting with the lowest (or alternatively: highest) priority class, or

all logical channels up to the logical channel Y starting with the logical channel having the largest (or alternatively: smallest) identity or number, or

all radio bearers up to radio bearer Y starting with the radio bearer having the largest (or alternatively: smallest) identity or number or, in general, any predefined sub-set, thus

a predefined sub-set of priority classes,

a predefined sub-set of logical channels,

a predefined sub-set of radio bearers,

or combinations of them (i.e. of sub-sets of priority classes, sub-sets of logical channels and sub-sets of radio bearers).

The number of the HARQ processes to be used can be configured. Since the Stop&Wait protocol blocks the data flow until an acknowledgement is received, as a rule at least two HARQ processes will be operated side by side. In this case there are then only 2 different STOP commands available. This, however, is not too great a disadvantage because with two HARQ processes the possible data rate is clearly smaller and thus it will be more seldom that a STOP command has to be sent. Generally, with N HARQ processes N different STOP commands are available which can be suitably assigned to the priority classes, logical channels or radio bearers by means of the mapping table.

Furthermore, the STOP commands may also be assigned to a plurality of HARQ processes for example to further enhance the reliability of the STOP command. If, for example, 4 HARQ processes are executed for transmission between base station and mobile station and if only one logical channel (one priority class, one radio bearer) is to be blocked, the STOP commands assigned to the 4 HARQ processes can be assigned to the logical channel (to the priority class, to the radio bearer). Thus in each TTI in which the mobile station receives data over the HS-DSCH, this STOP command for regulation of the one stream can be sent repeatedly. In order to enhance the reliability of the signal, the receiving base station is to wait with the blocking of the addressed stream until the base station has received the pre-defined number of STOP commands for this stream within a predefined time interval.

In order to avoid a command for removing the blocking, the base station starts a timer T_{STOP,BS} when the STOP command is received. As long as T_{STOP,BS} runs, the base station does not send any packets for the blocked stream. Once T_{STOP,BS} has stopped running, the base station can again send packets for the blocked stream. If a further blocking is then to take place, the mobile station again sends a STOP command. In addition, the mobile station, once it has sent a STOP command (as a result of a bottleneck when the data are to be transported to an external interface), can start a timer T_{STOP} in the mobile station, which timer has the same duration as T_{stop,BS}. As long as T_{STOP} has not stopped running, the mobile station does not expect any further data packets on the blocked stream. If, nevertheless, data for this stream arrive (which then denotes that the base station has not received the STOP command), the mobile station again sends a STOP command at which the timer is then started anew. Once the timer T_{STOP} has stopped running, the mobile station checks whether the bottleneck on the external link still exists. If this is the case, it again sends a STOP command which was configured for blocking all the sub-streams of this external link. This is particularly advantageous in the system that is described in “3GPP TS 25.321 V5.1.0 (2002-06) 3rd Generation Partnership Project; Technical Specification Group Radio Access Network; MAC protocol specification (Release 5)”. If the mobile station does not react until it is able to detect a data packet without any errors and establishes that this data packet contains data that can be passed on over the “bottleneck” external link, data will be uselessly sent for the external link until the data packet can be decoded error-free, so that only then can a STOP command be sent. Even if the mobile station could detect without an error-free decoding which streams are contained in a data packet (which, however, is not the case in a system described in “3GPP TS 25.321 V5.1.0 (2002-06) 3rd Generation Partnership Project; Technical Specification Group Radio Access Network; MAC protocol specification (Release 5)”), a useless downlink transmission would then be avoided by sending a STOP command after the timer has ended.

In addition to this, the base station can inform the mobile station in the header of a transmitted PDU for which stream it has received a STOP command. If this indication is lacking, once the mobile station has sent a STOP command, the mobile station assumes that the STOP command was not detected and sends it anew.

The mapping between the STOP command assigned to a HARQ process and the DL stream or DL streams to be controlled respectively (logical channel, priority class, radio bearer or sub-sets of them), which stream or streams this STOP command relates to, is announced to the mobile station and the base station when the data link is established for transmitting data over the HS-DSCH which is to be blocked as appropriate. This mapping instruction can also be complemented or, if already available, reconfigured when data links are already existing over the HS-DSCH.

1. A method of transmitting data packets between a transmitter and a receiver in predefined numbered slots, wherein the transmitter is provided for sending in one slot data of different streams multiplexed in a data packet to the receiver, wherein a STOP command is provided for at least one numbered slot, wherein the receiver is provided for sending the STOP command to the transmitter, wherein a mapping table is provided which maps each STOP command of the numbered slots to a set of streams of the respective slot, wherein the STOP command is provided for blocking a set of the streams of the respective slot according to the mapping table.

2. A method as claimed in claim 1, wherein the transmitter and the receiver are provided with the mapping table by means of a configuration message.

3. A method as claimed in claim 1, wherein the receiver, once it has sent a STOP command to block a set of streams, starts a timer assigned to this set and, once the timer has stopped running, sends a further STOP command in so far as the set of streams to be blocked are still to be blocked.

4. A terminal for receiving data from a transmitter in predefined numbered slots, wherein the transmitter is provided for sending in one slot data of different streams multiplexed in a data packet to the receiver, wherein a STOP command is provided for at least one numbered slot, wherein the terminal is provided for sending the STOP command to the transmitter, wherein a mapping table is provided which maps each stop command of the numbered slots to a set of streams of the respective slot, wherein the stop command is provided for blocking a set of the streams of the respective slot according to the mapping table.

5. A system comprising a transmitter and a receiver wherein data packets can be transmitted in predefined numbered slots between the transmitter and the receiver, wherein the transmitter is provided for sending in one slot data of different streams multiplexed in a data packet to the receiver, wherein a STOP command is provided for at least one numbered slot, wherein the receiver is provided for sending the STOP command to the transmitter, wherein a mapping table is provided which maps each stop command of the numbered slots to a set of streams of the respective slot, wherein the stop command is provided for blocking a set of the streams of the respective slot according to the mapping table.

6. A system as claimed in claim 5, wherein the transmitter is a base station and the receiver is a mobile station of a wireless or cellular telecommunications network.

7. A system as claimed in claim 5, wherein the slot numbers are given by the HARQ process numbers of the High Speed Downlink Shared Channel of a Universal Mobile Telecommunications System (UMTS).

8. A system as claimed in claim 5, wherein one of the bit combinations of the Channel Quality Indication of the downlink Time Transmission Interval of the Universal Mobile Telecommunications System (UMTS) is used for the signalling of the STOP command.

9. A system as claimed in claim 5, wherein the receiver is connectable to an electronic device via an air interface, in particular via a Bluetooth Interface or via a Infrared Interface.
